(19) United States
(12) Patent Application Publication
(10) Pub. No.: US 2011/0248960 A1
(43) Pub. Date: Oct. 13, 2011

(54) HOLOGRAPHIC TOUCHSCREEN

(75) Inventor: Russell Gruhlke, Milpitas, CA (US)

(73) Assignee: QUALCOMM MEMS Technologies, Inc., San Diego, CA (US)

(21) Appl. No.: 12/756,826

(22) Filed: Apr. 8, 2010

(51) Int. Cl. G06F 3/042; G01N 21/55

(52) U.S. Cl. 345/175; 356/445

(57) ABSTRACT

Disclosed are various embodiments of a holographic touchscreen and methods of configuring such devices. In certain embodiments, a touchscreen assembly can include a holographic layer configured to receive incident light and turn it into a selected direction to be transmitted through a light guide. The holographic layer can be configured to accept incident light within an acceptance range and so that the selected direction is within a range of directions so as to allow determination of incidence location based on detection of the turned light. A light source can be provided so that light from the source scatters from an object such as a fingertip near the holographic layer and becomes the incident light. The determined incidence location can represent presence of the fingertip at or near the incidence location, thereby providing touchscreen functionality. In certain embodiments, the distance between the fingertip and the holographic layer can be estimated based on measurement of a width of a distribution resulting from the detected directed light turned by the holographic layer.

### BACKGROUND

1. Field

The present disclosure generally relates to the field of user interface devices, and more particularly, to systems and methods for providing holographic based optical touchscreen devices.

2. Description of Related Technology

Certain user interface devices for various electronic devices typically include a display component and an input component. The display component can be based on one of a number of optical systems such as liquid crystal display (LCD) and interferometric modulator (IMOD).

In the context of certain display systems, electromechanical systems can include devices having electrical and mechanical elements, actuators, transducers, sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers or that add layers to form electrical and electromechanical devices. One type of electromechanical device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

In certain embodiments, the present disclosure relates to a screen assembly for an electronic device. The screen assembly includes a display device configured to display an image by providing signals to selected locations of the display device. The screen assembly further includes an input device disposed adjacent the display device. The input device includes a holographic layer configured to receive incident light and direct the incident light towards at least one selected direction, with the incident light resulting from scattering of at least a portion of illumination light from an object positioned relative to the holographic layer. The screen assembly further includes a detector configured to detect the directed light and capable generating signals suitable for obtaining a distribution of the directed light along the at least one selected direction. The distribution has a parameter, such as a width, that changes substantially monotonically with a separation distance between the holographic layer and the object such that measurement of the parameter provides information about the separation distance.

In certain embodiments, the screen assembly can further include a light guide disposed relative to the holographic layer so as to receive the directed light from the holographic layer and guide the directed light for at least a portion of the directed light's optical path to the detector. In certain embodiments, the screen assembly can also include one or more light sources configured to provide the illumination light to the object.

In certain embodiments, the present disclosure relates to a method for determining a distance of an object from a screen. The method includes obtaining redirected light from an optical layer of the screen, with the redirected light resulting from incidence of light scattered from the object at a distance from the screen. The optical layer is configured to receive an incident ray that is within an acceptance range relative to the optical layer and redirect the accepted incident ray, with the redirected light resulting from a collection of accepted incident rays from the object. The method further includes detecting the redirected light and generating signals based on the detection of the redirected light. The method further includes obtaining a distribution of the redirected light based on the signals, and calculating a width parameter from the distribution, with the width of the distribution changing substantially monotonically with the distance such that the width provides information about the distance of the object from the screen.

In certain embodiments, the present disclosure relates to a touchscreen apparatus having a holographic layer configured to receive accepted incident light and direct the incident light towards a selected direction, with the accepted incident light resulting from scattering of illumination light from an object at or separated by a distance from a surface of the holographic layer. The apparatus further includes a light guide disposed relative to the holographic layer so as to receive the directed light from the holographic layer and guide the directed light towards an exit portion of the light guide. The apparatus further includes a segmented detector disposed relative to the light guide and configured to detect the directed light exiting from the exit portion so as to allow determination of a distribution of the directed light along at least one lateral direction on the holographic layer, with the distribution having a width that changes substantially monotonically the separation distance such that measurement of the width provides information about the separation distance.

In certain embodiments, the touchscreen apparatus can further includes a light source disposed relative to the holographic layer and configured to provide light to the object to yield the accepted incident light. In certain embodiments, the touchscreen apparatus can further include a light guide plate configured to receive light from the source and provide the light to the object from a side of the holographic layer that is opposite from the side where the object is located.

In certain embodiments, the touchscreen apparatus can further include a display; a processor that is configured to communicate with the display, with the processor being configured to process image data; and a memory device that is configured to communicate with the processor.

In certain embodiments, the present disclosure relates to a method for fabricating a touchscreen. The method includes forming a diffraction pattern in or on a substrate layer defining a plane and having first and second sides. The diffraction pattern is configured such that a light ray incident at a selected angle on the first side of the substrate layer is diffracted into a turned ray that exits on the second side of the substrate layer along a direction having a selected lateral component parallel with the plane of the substrate layer. The method further includes coupling the substrate layer with a light guide layer that defines a plane substantially parallel to the plane of the substrate layer, with the light guide layer being on the second side of the substrate layer and configured to received the turned light exiting from the substrate layer and guide the turned light substantially along the direction. The method further includes coupling the light guide layer with a light guide plate such that the light guide layer is between the substrate layer and the light guide plate. The light guide plate is configured to provide illumination light to an object on the first side of the substrate layer such that at least a portion of the illumination light scatters from the object and yields the incident light ray.

In certain embodiments, the present disclosure relates to an apparatus having means for displaying an image on a display device by providing signals to selected locations of the display device. The apparatus further includes means for optically determining a separation distance between an input inducing object and a screen. The separation distance is coordinated with the image on the display device, the separation distance obtained from measurement of a width of a distribution of light resulting from turning of accepted portion of scattered light from the object by a hologram.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 shows that in certain embodiments, an interface device can include a display device and an input device.

FIG. 9A shows a side view of an example embodiment of the input device having a holographic layer and a light guide.

FIG. 9B shows a partial cutaway plan view of the input device of FIG. 9A.

FIGS. 10A and 10B show plan and side views of an example embodiment of the input device configured to detect presence of an object such as a fingertip above the holographic layer, where the detection can be facilitated by illumination from a source positioned above the holographic layer.

FIGS. 11A and 11B show that in certain embodiments, selected light rays from the example source of FIGS. 10A and 10B reflected from the object can be incident on and be accepted by the holographic layer and be directed in one or more selected directions so as to allow determination of incidence location.

FIGS. 12A and 12B show plan and side views of an example embodiment of the input device configured to detect presence of an object such as a fingertip above the holographic layer, where the detection can be facilitated by illumination from a source positioned below the holographic layer.

FIGS. 13A and 13B show that in certain embodiments, selected light rays from the example illumination configuration of FIGS. 12A and 12B reflected from the object can be incident on and be accepted by the holographic layer and be directed in one or more selected directions so as to allow determination of incidence location.

FIG. 14 shows that in certain embodiments, the holographic layer can be configured to accept and redirect incident rays that are within a selected range of incident angles.

FIGS. 15A and 15B show that for an acceptance range defined by a cone relative to the holographic layer, incident rays reflected from an object such as a fingertip are generally accepted within an area on the holographic layer with the area's dimension generally increasing as the distance between the fingertip and the surface increases.

FIG. 16 shows that in certain embodiments, a fingertip in contact with the surface of the holographic layer can also result in reflected rays being accepted within an area on the surface.

FIG. 17 depicts the various example acceptance areas of FIGS. 15 and 16, and how one or more lateral dimensions of such areas can be characterized based on detection of redirected rays by one or more detectors such as line array detectors.

FIG. 18 shows that in certain embodiments, a width of the detected distribution can increase generally monotonically as the distance between the fingertip and the surface of the holographic layer increases, thereby allowing determination of where the fingertip is relative to the surface based on the measured width of the distribution.

FIG. 19 shows that in certain embodiments, location of where the fingertip makes contact with the surface of the holographic layer, as well as how the contact is made, can be determined by the characterization of the acceptance area.

FIG. 20 shows an example process that can be implemented to determine the position of the fingertip relative to the surface of the holographic layer, including the fingertip's distance from the surface.

FIG. 21 shows a block diagram of an electronic device having various components that can be configured to provide one or more features of the present disclosure.

### DETAILED DESCRIPTION

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

In certain embodiments as described herein, a display device can be fabricated using one or more embodiments of interferometric modulators. At least some of such modulators can be configured to account for shifts in output colors when the display device is viewed at a selected angle so that a desired color output is perceived from the display device when viewed from the selected angle.

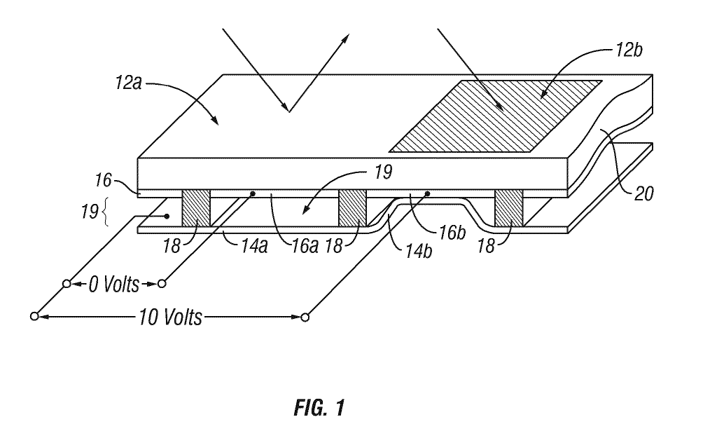

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

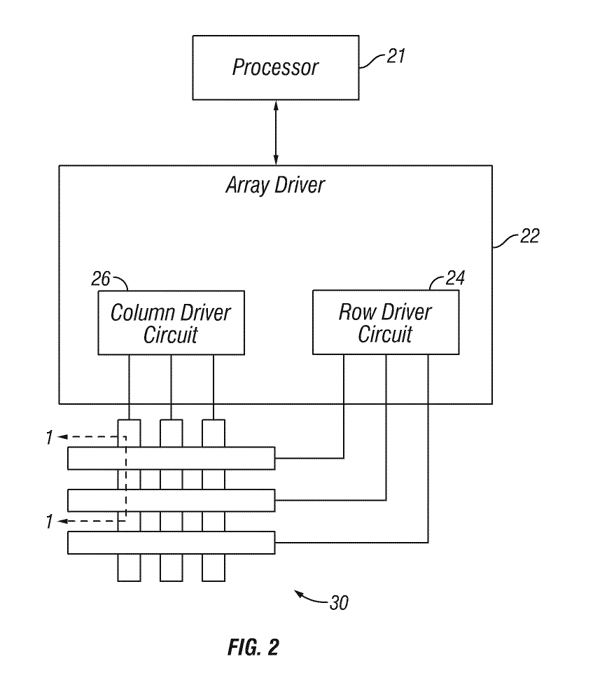

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

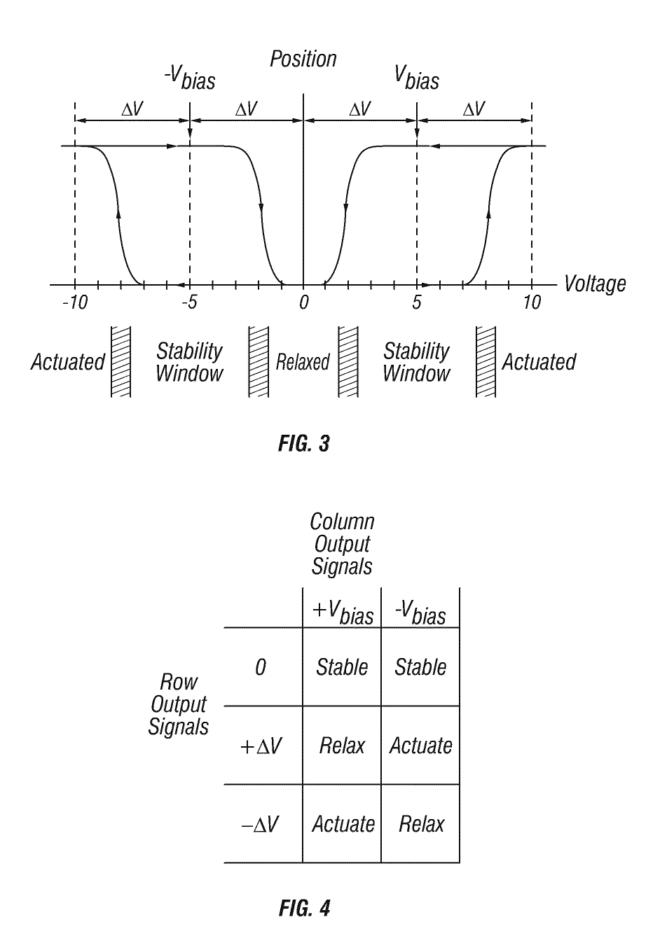

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

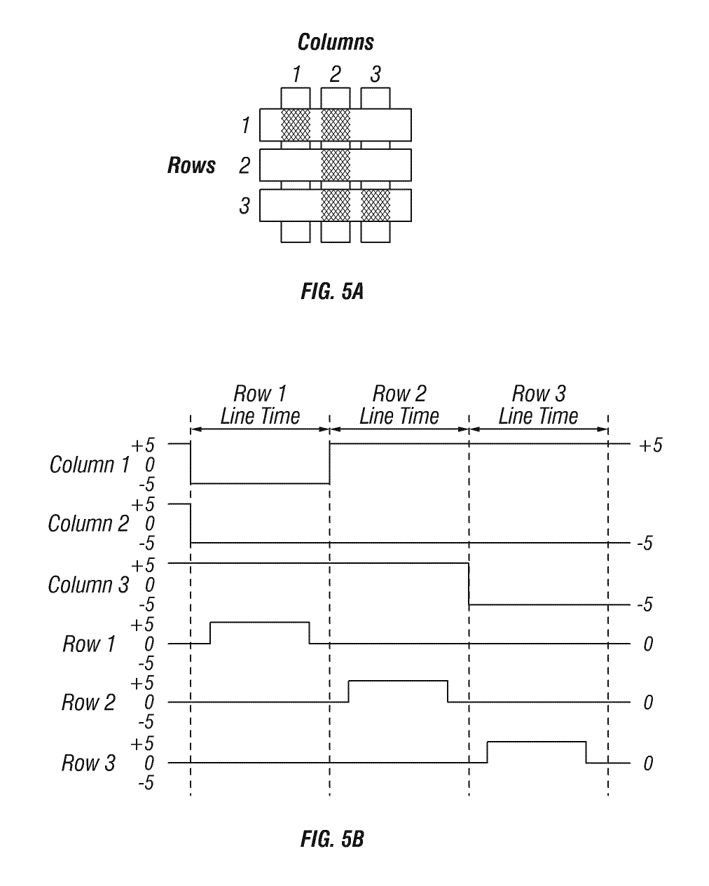

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

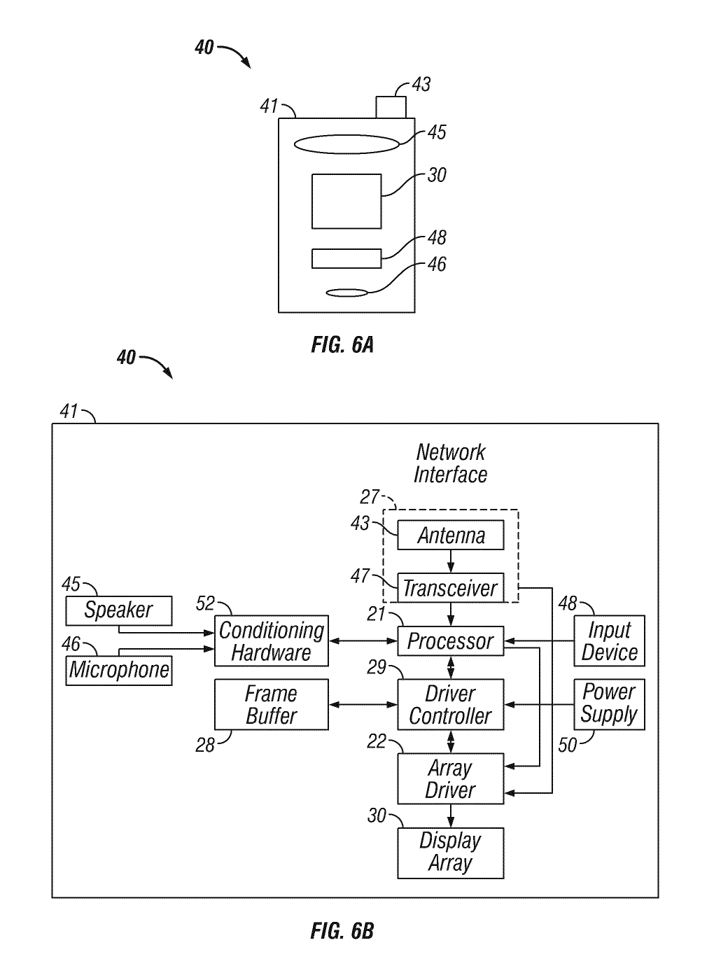

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one or more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

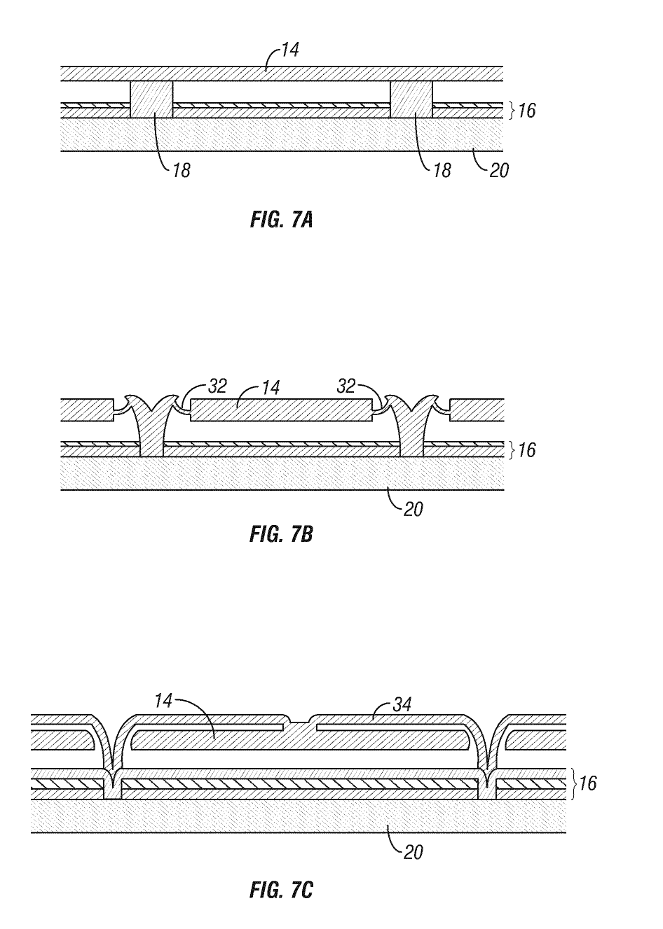

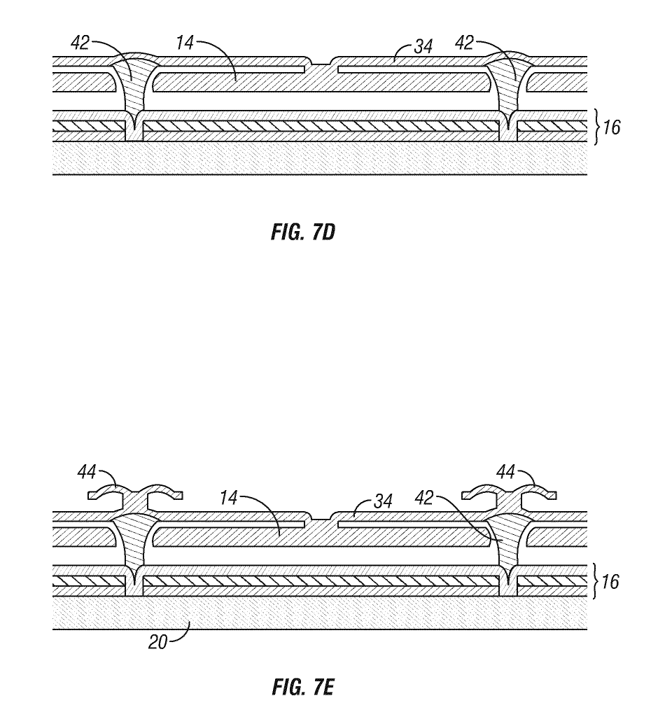

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

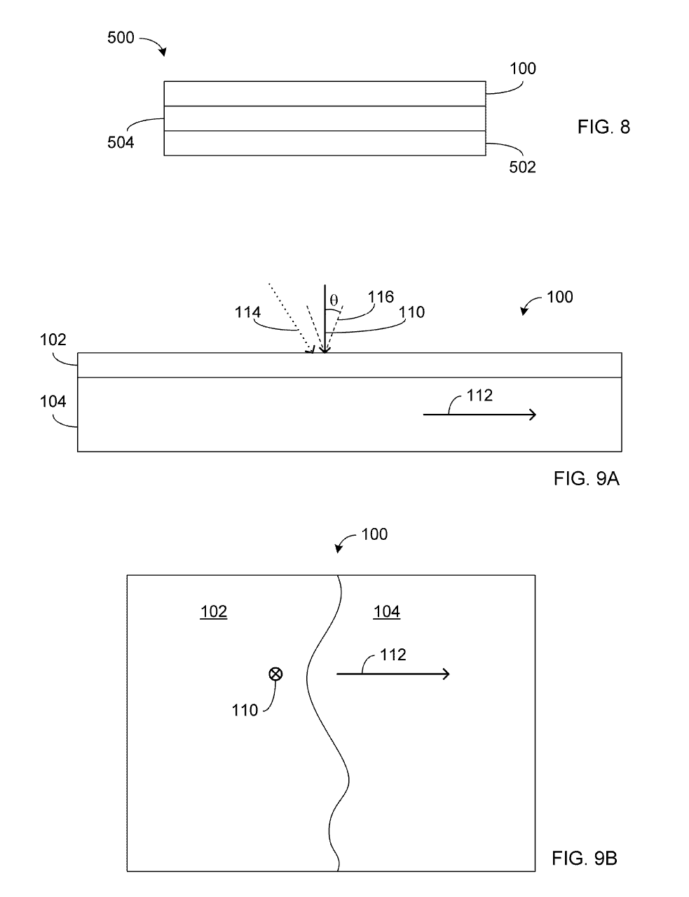

FIG. 8 shows that in certain embodiments, an interface device 500 can include a display device 502 and an input device 100. The input device can include a contact sensing mechanism configured to facilitate determination of location where contact is made. Such contacts can be made by objects such as a fingertip or a stylus. The interface device 500 can be part of a variety of electronic devices such as portable computing and/or communication devices to provide user interface functionalities.

In certain embodiments, the display device 502 can include one or more features or embodiments of various devices, methods, and functionalities as described herein in reference to FIGS. 1-7. In other words, such devices can include various embodiments of interferometric modulators, including but not limited to the examples of embodiments of interferometric modulators described and/or illustrated herein.

In certain embodiments, the input device 100 can be combined with an interferometric modulator based display device to form the interface device 500. As described herein, however, various features of the input device 100 do not necessarily require that the display device 502 be a device based on interferometric modulators. In certain embodiments, the display device 502 can be one of a number of display devices, such as a transreflective display device, an electronic ink display device, a plasma display device, an electro chromism display device, an electro wetting display device, a DLP display device, an electro luminescence display device. Other display devices can also be used.

FIG. 8 shows that in certain embodiments, an optical isolation region 504 can be provided between the display device 502 and the input device 100. In certain embodiments as described herein, the input device 100 can include a light guide that guides light that is selectively directed by a holographic layer. In such a configuration, the isolation region 504 can have a lower refractive index than the light guide. This low refractive index region may act as an optical isolation layer for the light guide. In such embodiments, the interface of light guide and low refractive index (n) layer forms a TIR (total internal reflection) interface. Light rays within the light guide which are incident on the interface at greater than the critical angle (e.g., 40°), as measured with respect to the normal to the surface, will be specularly reflected back into the light guide. The value of n can be less than the refractive index of the light guide, and may, for example be a layer of material such as a layer of glass or plastic. In certain embodiments, the low index region can include an air gap or a gap filled with another gas or liquid. Other materials for the low refractive index region may also be used. In some embodiments, the material is substantially optically transparent such that the display device 502 may be viewed through the material.

In certain embodiments, the input device 100 of FIG. 8 can be configured to have one or more features disclosed herein, and can be implemented in interface devices such as a touchscreen. As generally known, a touchscreen allows a user to view and make selections directly on a screen by touching an appropriate portion of the screen. In one or more embodiments described herein, it will be understood that “touchscreen” or “touch screen” can include configurations where a user inputs may or may not involve physical contact between a touching object (such as a fingertip or a stylus) and a surface of a screen. As described herein, location of the “touching” object can be sensed with or without such physical contact.

In certain embodiments, a user interface such as a touchscreen can include a configuration 100 schematically depicted in FIGS. 9A and 9B, where FIG. 9A shows a side view and FIG. 9B shows a partially cutaway plan view. A holographic layer 102 is depicted as being disposed adjacent a light guide 104. Although the holographic layer 102 and the light guide 104 are depicted as being immediately adjacent to each other, it will be understood that the two layers may or may not be in direct contact. Preferably, the holographic layer 102 and the light guide 104 are coupled so as to allow efficient transmission of light.

In certain embodiments, the holographic layer 102 can be configured to accept incident light travelling within a selected range of incidence angle and transmit a substantial portion of the accepted light towards a selected range of transmitted direction in the light guide 104. For example, a light ray 110 is depicted as being within an example incidence acceptance range 116 and incident on the holographic layer 102. Thus, the ray 110 can be accepted and be directed as transmitted ray 112 in the light guide 104. Another example incident light ray 114 (dotted arrow) is depicted as being outside of the acceptance range 116; and thus is not transmitted to the light guide 104.

In certain embodiments, the incidence acceptance range (e.g., 116 in FIG. 9A) can be a cone about a normal line extending from a given location on the surface of the holographic layer 102. The cone can have an angle θrelative to the normal line, and θ can have a value in a range of, for example, approximately 0 to 15 degrees, approximately 0 to 10 degrees, approximately 0 to 5 degrees, approximately 0 to 2 degrees, or approximately 0 to 1 degree.

In certain embodiments, the incidence acceptance range does not need to be symmetric about the example normal line. For example, an asymmetric acceptance cone can be provided to accommodate any asymmetries associated with a given device and/or its typical usage.

In certain embodiments, the incidence acceptance range can be selected with respect to a reference other than the normal line. For example, a cone (symmetric or asymmetric) about a non-normal line extending from a given location on the surface of the holographic layer 102 can provide the incidence acceptance range. In certain situations, such angled acceptance cone can also accommodate any asymmetries associated with a given device and/or its typical usage.

In certain embodiments, the holographic layer 102 configured to provide one or more of the features described herein can include one or more volume or surface holograms. More generally, the holographic layer 102 may be referred to as diffractive optics, having for example diffractive features such as volume or surface features. In certain embodiments, the diffractive optics can include one or more holograms. The diffractive features in such embodiments can include holographic features.

Holography advantageously enables light to be manipulated so as to achieve a desired output for a given input. Moreover, multiple functions may be included in a single holographic layer. In certain embodiments, for instance, a first hologram comprising a first plurality of holographic features that provide for one function (e.g., turning light) and a second hologram comprising a second plurality of holographic features provide for another function (e.g. collimating light). Accordingly, the holographic layer 102 may include a set of volume index of refraction variations or topographical features arranged to diffract light in a specific manner, for example, to turn incident light into the light guide.

A holographic layer may be equivalently considered by one skilled in the art as including multiple holograms or as including a single hologram having for example multiple optical functions recorded therein. Accordingly, the term hologram may be used herein to describe diffractive optics in which one or more optical functions have been holographically recorded. Alternately, a single holographic layer may be described herein as having multiple holograms recorded therein each providing a single optical function such as, e.g., collimating light, etc.

In certain embodiments, the holographic layer 102 described herein can be a transmissive hologram. Although various examples herein are described in the context of a transmissive hologram, it will be understood that a reflective hologram can also be utilized in other embodiments.

The transmissive holographic layer can be configured to accept light within an angular range of acceptance relative to, for example, the normal of the holographic layer. The accepted light can then be directed at an angle relative to the holographic layer. For the purpose of description, such directed angle is also referred to as a diffraction angle. In certain embodiments, the diffraction angle can be between about 0 degree to about 90 degrees (substantially perpendicular to the holographic layer).

In certain embodiments, light accepted by the hologram may be in a range of angles having an angular width of full width at half maximum (FWHM) between about 2° to 10°, 10° to 20°, 20° to 30°, 30° to 40°, 40° to 50° and may be centered at an angle of about 0 to 5°, 5° to 10°, 10° to 15°, 15° to 20°, 20° to 25° with respect to the normal to the holographic layer. In certain embodiments, light incident at other angles outside the range of acceptance angles can be transmitted through the holographic layer at angles determined by Snell's law of refraction. In certain embodiments, light incident at other angles outside the range of acceptance angles of the holographic layer can be reflected at an angle generally equal to the angle of incidence.

In some embodiments, the acceptance range may be centered at angles of about 0, about 5, about 10, about 15, about 20, about 25, about 30, about 35, about 40, about 45, about 50, about 55, about 60, about 65, about 70, about 75, about 80, or about 85 degrees, and may have a width (FWHM, for example) of about 1, about 2, about 4, about 5, about 7, about 10, about 15, about 20, about 25, about 30, about 35, about 40, or about 45 degrees. The efficiency of the hologram may vary for different embodiments. The efficiency of a hologram can be represented as the ratio of (a) light incident within the acceptance range which is redirected (e.g., turned) by the hologram as a result of optical interference caused by the holographic features to (b) the total light incident within the range of acceptance, and can be determined by the design and fabrication parameters of the hologram. In some embodiments, the efficiency is greater than about 1%, about 5%, about 10%, about 15%, about 20%, about 25%, about 30%, about 35%, about 40%, about 45%, about 50%, about 55%, 60%, about 65%, about 70%, about 75%, about 80%, about 85%, about 90%, or about 95%.

To provide for the different acceptance angles, multiple hologram of sets of holographic features may be recorded within the holographic layer. Such holograms or holographic features can be recorded by using beams directed at different angles.

For example, a holographic recording medium may be exposed to one set of beams to establish a reflection hologram. The holographic recording medium may additionally be exposed to a second set of beams to record a transmission hologram. The holographic recording medium may be developed such that the two holograms are formed, for example, in a single layer. In such an arrangement, two sets of holographic features, one corresponding to the reflection hologram and one corresponding to the transmission hologram are formed. One skilled in the art may refer to the aggregate structure as a single hologram or alternately as multiple holograms.

Optical or non-optical replication processes may be employed to generate additional holograms. For example, a master can be generated from the developed layer and the master can be used to produce similar holograms having the two sets of holographic features therein to provide the reflective and transmissive functionality. Intermediate structures may also be formed. For example, the original can be replicated one or more times before forming the master or product.

As described above, the replicated holographic structure may be referred to as a single hologram comprising multiple sets of holographic features that provide different functions. Alternatively, the sets of holographic features providing different functions can be referred to as different holograms.

The holographic features may comprise, for example, surface features or volume features of the holographic layer. Other methods can also be used. The holograms may for example be computer generated or formed from a master. The master may or may not be computer generated. In some embodiments, different methods or a combination of methods are used.

A wide variety of variation is possible. Films, layers, components, and/or elements may be added, removed, or rearranged. Additionally, processing steps may be added, removed, or reordered. Also, although the terms film and layer have been used herein, such terms as used herein include film stacks and multilayers. Such film stacks and multilayers may be adhered to other structures using adhesive or may be formed on other structures using deposition or in other manners. Similarly, as described above, sets of holographic features providing multiple functionality may integrated together in a single layer or in multiple layers. Multiple sets of holographic features included in a single layer to provide multiple functionality may be referred to as a plurality of holograms or a single hologram.

As described in reference to FIGS. 9A and 9B, certain light rays incident on the holographic layer 102 can be redirected into the light guide. In certain embodiments, such redirected light can be detected so as to allow determination of the incidence location on the holographic layer 102.

In certain embodiments, light rays (e.g., ray 110) that are incident on the holographic layer 102 can result from interaction of illumination light with an object proximate the holographic layer 102. For the purpose of description herein, such interaction between the illumination light and the object is described as reflection and/or scattering; and sometimes the two terms may be used interchangeably.

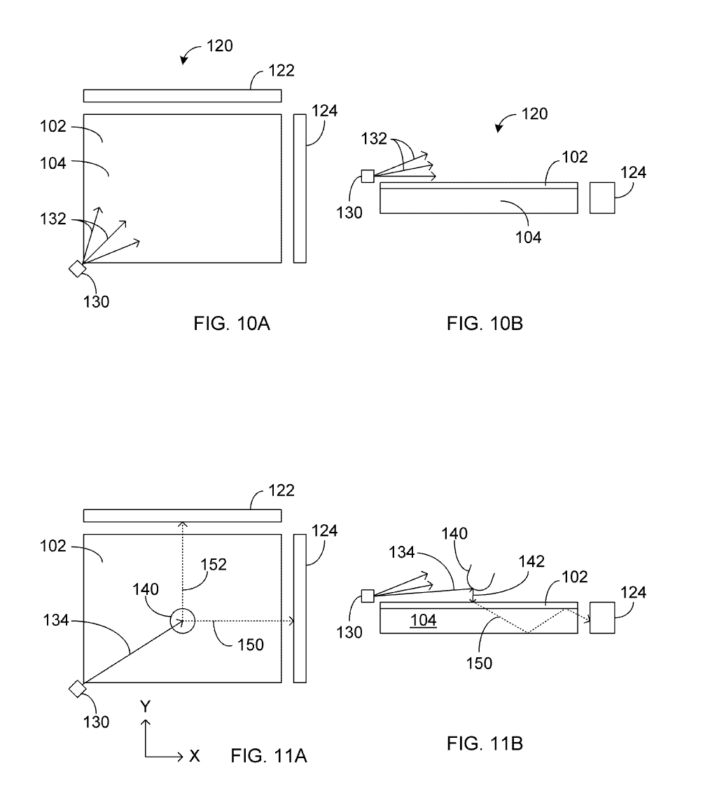

FIGS. 10 and 11 show an example configuration of a touchscreen assembly 120 and its usage where incidence of light on the holographic layer 102 can be facilitated by reflection of light by an object 140 (for example, a fingertip or stylus) near the holographic layer 102. In certain embodiments, such light to be reflected (by the object 140) and directed to the holographic layer 102 can be provided by one or more light sources disposed on the same side of the holographic layer 102 as where the reflection occurs. In the example side view depicted in FIGS. 10B and 11B, the reflection from the object 140 is shown to be above the holographic layer 102. In other words, the reflection from the object 140 is shown to be on a side of the holographic layer 102 which is opposite of the side adjacent to the light guide 104.

FIGS. 10A and 10B schematically depict plan and side views, respectively, of the example touchscreen assembly 120. A light source 130 can be disposed relative to the holographic layer 102 so as to provide light rays 132 to a region adjacent the holographic layer 102 (e.g., above the holographic layer 102 if the assembly 120 is oriented as shown in FIG. 10B where the light guide 104 is disposed “below” the holographic layer 102).

As shown in FIG. 11B, some of the light rays 132 can scatter from the fingertip 140 so as to yield an accepted incident ray (arrow 142) described in reference to FIGS. 9A and 9B. In certain embodiments, the light source 130 can be configured so that its light 132 spreads and provides illumination to substantially or all of the lateral region adjacent the holographic layer 102. The light source 130 can also be configured so as to limit the upward angle (assuming the example orientation of FIG. 10B) of the illumination light 132, so as to reduce the likelihood of an accepted incident light resulting from an object that is undesirably distant from the holographic layer 102.

In certain embodiments, the light source 130 can be configured so that its illumination light 132 is sufficiently distinguishable from ambient and/or background light. For example, an infrared light emitting diode (LED) can be utilized to distinguish the illumination light and the redirected light from ambient visible light. In certain embodiments, the light source 130 can be pulsed in a known manner to distinguish the illumination light from the background where infrared light is also present.

In FIG. 11B, the accepted incident ray 142 is depicted as being redirected to the right side, entering the light guide 104, and propagating to the right as a guided ray 150. The guided ray 150 is further depicted as exiting the light guide 104 and being detected by a detector 124.

In certain embodiments, the detector 124 can have an array of photo-detectors extending along a Y direction (assuming the example coordinate system shown in FIG. 11A) to allow determination of the exit location of the guided light 150. Thus, by knowing the redirecting properties of the holographic layer 102, Y value of the incidence location can be determined.

In certain embodiments, a similar detector 122 can be provided so as to allow determination of X value of the incidence location. In certain embodiments, the holographic layer 102 can be configured to provide redirection of accepted incident light into both X and Y directions.

In certain embodiments, holographic layer 102 can be configured so that the redirected light (e.g., 150 or 152 in FIG. 11A) propagates from the incidence location within a redirection range. In certain embodiments, the redirection range can be within an opening angle that is, for example, approximately 0 to 40 degrees, approximately 0 to 30 degrees, approximately 0 to 20 degrees, approximately 0 to 10 degrees, approximately 0 to 5 degrees, or approximately 0 to 2 degree. Thus, when the holographic layer 102 is aligned appropriately with the light guide 104 and the detectors 122, 124, the guided light can have similar direction range with respect to the XY plane.

In certain embodiments, the detectors 122 and 124 can be configured and disposed relative to the light guide 104 to allow detection of the corresponding guided light (152 and 150 in FIG. 11A) with sufficient resolution. For example, if the holographic layer 102 is capable of redirecting light into a relatively narrow range, the detector can be provided with sufficient segmentation to accommodate such resolution capability.

In the example detection configuration of FIGS. 10 and 11, the detectors 122 and 124 can be line sensor arrays positioned along the edges of the light guide (e.g., along X and Y directions). It will be understood that other configurations of detectors and/or their positions relative to the light guide are also possible.

In certain embodiments, for example, discrete sensing elements such as point-like sensors can be positioned at or near two or more corners of the light guide. Such sensors can detect light propagating from an incidence location; and the incidence location can be calculated based on, for example, intensities of light detected by the sensors. By way of an example, suppose that a point-like sensor is positioned at each of the four corners of a rectangular shaped light guide. Assuming that responses of the four sensors are normalized in some known manner, relative strengths of signals generated by the sensors can be used to calculate X and/or Y values of the incidence location. In certain embodiments, the foregoing detection configuration can be facilitated by a holographic layer that is configured to diffract incident light along a direction within a substantially full azimuthal range of about 0 to 360 degrees. Such a holographic layer can further be configured to diffract incident light along a polar direction within some range (e.g., approximately 0 to 40 degrees) of an opening angle.

In certain embodiments; the forgoing sensors placed at the corners of the light guide can be positioned above, below, or at generally same level as the light guide. For example, to accommodate configurations where the sensors are below the light guide (on the opposite side from the incidence side), a holographic layer can be configured to diffract an incident ray into the light guide such that the ray exits the opposite side of the light guide at a large angle (relative to the normal) and propagate towards the sensors. Such a large exit angle relative to the normal can be achieved by, for example, having the diffracted ray's polar angle be slightly less than the critical angle of the interface between the light guide and the medium below the light guide. If the light guide is formed from glass and air is below the light guide, the ray's polar angle can be selected to be slightly less than about 42 degrees (critical angle for glass-air interface) so as to yield a transmitted ray that propagates in the air nearly parallel to the surface of the light guide.

As described herein, the light source 130 can be configured so that its illumination light 132 is distinguishable from ambient and/or background light. In certain embodiments, the detectors 122 and 124 can also be configured to provide such distinguishing capabilities. For example, one or more appropriate filters (e.g., selective wavelength filter(s)) can be provided to filter out undesirable ambient and/or background light.

Based on the foregoing, location of an object touching or in proximity to the holographic layer can be determined, thereby providing a user interface functionality. Because such location determination is by optical detection and does not rely on physical pressure of the object on the screen, problems associated with touchscreens relying on physical contacts can be avoided.

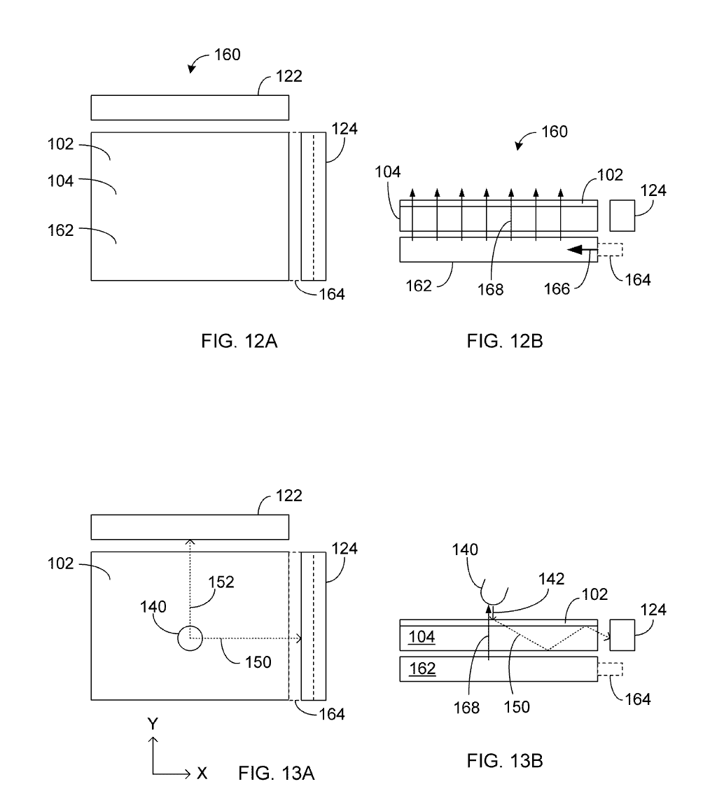

FIGS. 12 and 13 show another example configuration of a touchscreen assembly 160 and its usage where incidence of light on the holographic layer 102 can be facilitated by reflection of light by an object 140 (for example, a fingertip or a stylus) on or at a distance from the holographic layer 102. In certain embodiments, such illumination light to be reflected (by the object 140) and directed to the holographic layer 102 can be provided by one or more light sources configured so as to provide light from the side of the holographic layer 102 that is opposite from the side where the reflection occurs. In the example side view depicted in FIGS. 12B and 13B, the reflection from the object 140 is shown to occur on the side that is above the holographic layer 102, while the illumination is provided from the side that is below the holographic layer 102.

FIGS. 12A and 12B schematically depict plan and side views, respectively, of the example touchscreen assembly 160. A light source 164 can be disposed relative to the holographic layer 102 and configured so as to provide light rays 168 from the side (of the holographic layer 102) that is opposite of where reflection (from the object 140) and incidence (for redirection) occur. In the example orientation depicted in FIG. 12B, the light rays 168 are provided from underneath the holographic layer 102 and travel upward to the side above the holographic layer 102.

In certain embodiments, light (depicted as arrow 166) from the source 164 can be turned into the light rays 168 via a light guide plate 162 in one or more known manners.

As shown in FIG. 13B, some of the light rays 168 can scatter from the fingertip 140 so as to yield an accepted incident ray (arrow 142) described in reference to FIGS. 9A and 9B. Redirecting of the incident ray 142 by the holographic layer 102, guiding of the redirected ray 150, and detection of the redirected ray 150 by the detectors 122, 124 can be achieved similar to those described in reference to FIGS. 9-11.

Similarly, in certain embodiments, the light source 164 and/or the light guide plate 162 can be configured so that the illumination light 166 and/or the light rays 168 are sufficiently distinguishable from ambient and/or background light, as described in reference to FIGS. 9-11.

Similarly, in certain embodiments, detection of the redirected light and determination of the fingertip's X and/or Y position relative to the holographic layer 102 can be achieved as described in reference to FIGS. 9-11.

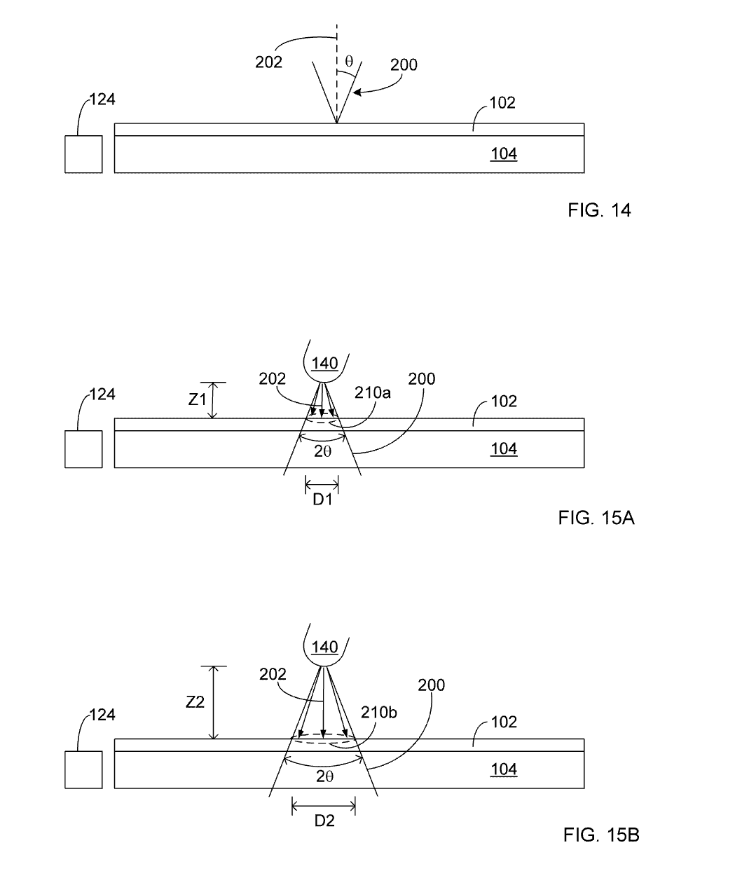

FIG. 14 shows that in certain embodiments, a holographic layer 102 can be configured to have an acceptance range 200 relative to a location on the layer 102. Such a range 102 can be, for example, a cone shaped region about a normal line 202 with respect to the surface of the holographic layer 102.

For the purpose of describing various features associated with FIGS. 14-19, it will be assumed that the cone shaped acceptance region 200 is generally symmetric about the normal line 202 so as to extend +/−θ about the normal line. It will be understood, however, that other forms of acceptance range can also be utilized. For example, a cone can deviate from circular symmetry into shapes such as an ellipse, where the ellipse's axes are directed along X and Y directions defined on the holographic layer. In another example, a cone can be formed relative to an axis that is not normal to the surface of the holographic layer 102. A number of other variations are also possible.

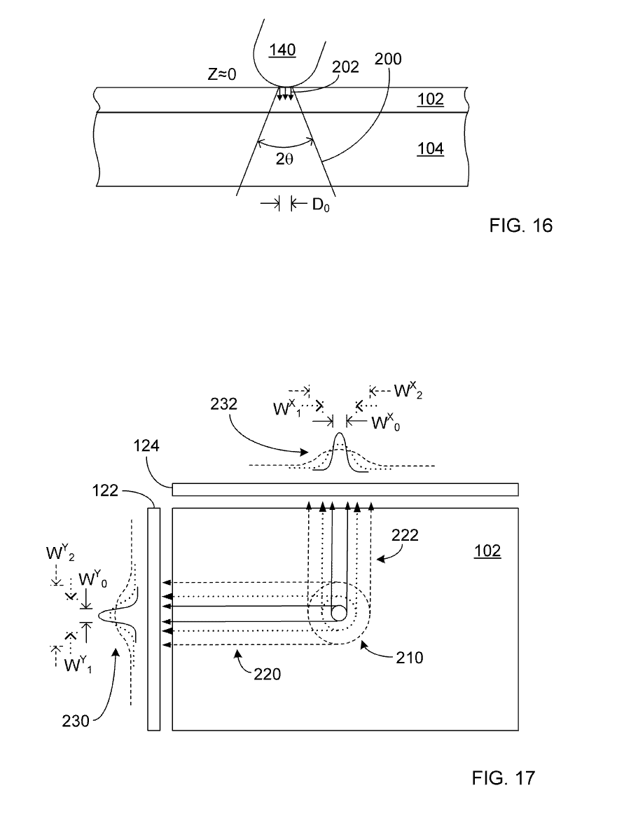

FIG. 14 further shows a light guide 104 positioned adjacent the holographic layer 102, and a detector 124 positioned relative to the light guide 104, shown here as positioned along the left edge of the light guide 104. FIGS. 15 and 16 show examples of how reflected light rays from an object 140 such as a fingertip can be accepted by the holographic layer 102 of FIG. 14. Since front illuminated configuration (e.g., FIGS. 10 and 11) and/or back illumination configuration (e.g., FIGS. 12 and 13) can be implemented, illuminating components are not shown for the purpose of description of FIGS. 14-16.

Referring to FIGS. 15A and 15B, it is noted that when the object 140 is positioned above the surface of the holographic layer 102, a reflecting portion of object 140 is at a distance of Z from the surface. The reflecting portion of the object 140 can vary in size, shape, and/or reflectivity depending on what the object 140 is. As shown, the reflecting portion is depicted as yielding reflected rays 202 towards the holographic layer 102 along a number of directions. For the example cone-shaped acceptance configuration of FIG. 14, it can be seen that scattered rays that are accepted can be in an acceptance cone relative to the reflecting portion. Such a cone can be approximated as an inverted cone that opens at an angle of 2θ, with its apex at or near the reflecting portion of the object 140.

As shown in FIGS. 15A and 15B, the inverted acceptance cone projects onto the surface of the holographic layer 102 an incidence region 210. If the inverted acceptance cone is substantially symmetric (e.g., circular shaped section) and formed about a normal line, then the incidence region 210 will likely form a circular shaped region. Factors such as asymmetry of the reflecting portion of the object and/or deviation of the inverted acceptance cone from the normal line can result in the incidence region 210 being asymmetrical.

Whether or not the inverted acceptance cone and the resulting incidence region 210 are symmetrical, the incidence region 210 can be characterized as having a dimension D along a given direction. For a specific example where the incidence region 210 is generally circular, the dimension D can represent, for example, the diameter of the circle.

In the examples shown in FIG. 15A, the incidence region 210a is depicted as having a dimension of D1 when the reflecting portion of the object 140 is at a distance of Z1 from the surface. In FIG. 15B where the object 140 is further away from the surface (Z=Z2), the resulting incidence region 210b has a dimension of D2 which is greater than D1. In certain embodiments, the dimension D of the incidence region 210 increases generally monotonically when the distance Z increases. In the specific example where the inverted acceptance cone is symmetrical about a normal line and yields a circular shaped incidence region, the diameter of the incidence region can be represented as D=2Z tan θ. One can see that D is proportional to Z. In configurations where the acceptance range angle θ is fixed, one can see that D depends only on Z in the foregoing example representation.

FIG. 16 shows an example situation where the object 140 is touching the surface of the holographic layer 102, such that Z≈0. For embodiments where reflection from the object 140 into the holographic layer 102 is practical in such a contact situation (e.g., via the example back-illumination of FIGS. 12 and 13), reflected rays 202 that are incident on an incidence region can be accepted by the holographic layer 102. In the example shown in FIG. 16, the incidence region resulting from the contact situation is depicted as having a dimension D₀. In certain embodiments, the dimension D₀ can be representative of a dimension associated with the contact surface area. In certain embodiments, the dimension D₀ (at Z≈0) is less than the dimension when Z>0.

Based on the examples of FIGS. 15 and 16, various incidence regions 210 are depicted on a plan view of the holographic layer 102 in FIG. 17. The incidence region depicted by a solid line corresponds to the contact situation of FIG. 16, and the incidence regions depicted by dotted line and dashed lines correspond to the Z1 and Z2 situations of FIGS. 15A and 15B, respectively.

For each of the example incidence regions 210, envelopes of redirected rays (represented as 220 and 222) are depicted as being guided toward their respective detectors 122 and 124. Detection of a given envelope of redirected rays can yield signals representative of a spatial distribution of the redirected rays from the incidence region 210. In certain embodiments, the spatial distribution of the detected rays can include an intensity distribution along the detector's direction of coverage. For example, the detector 122 can be a line array detector that provides coverage along Y direction so as to facilitate determination of a measured intensity distribution along the Y direction. Similarly, the detector 124 can be a line array detector that provides coverage along X direction so as to facilitate determination of a measured intensity distribution along the X direction.

Accordingly, FIG. 17 depicts examples of measured distributions 230, 232 that can be obtained from the detection of the redirected rays 220, 222 from the incidence regions 210. In certain embodiments, a parameter representative of a width of the distribution can be obtained. Such a parameter can include, for example, standard deviation σ, full width at half maximum (FWHM), and the like, which can be calculated from the distribution in known manners.

In FIG. 17, the calculated widths of the measured distributions 230, 232 are indicated as W^{Y}₀ (width along the Y direction for incidence region dimension D₀), W^{Y}₁ (width along the Y direction for incidence region dimension D₁), W^{Y}₂ (width along the Y direction for incidence region dimension D₂), W^{X}₀ (width along the X direction for incidence region dimension D₀), W^{X}₁ (width along the X direction for incidence region dimension D₁), and W^{X}₂ (width along the X direction for incidence region dimension D₂).

Although the incidence regions 210 are depicted as being generally circular in FIG. 17 for the purpose of description, it will be understood that such incidence regions can have other shapes, and may or may not have one or more degrees of symmetry. Further, it will be understood that the measured distributions 230, 232 also may or may not be symmetric. Further, for a given incidence region, the resulting X and Y distributions can be different with respect to, for example, general shape, width, and/or amplitude.

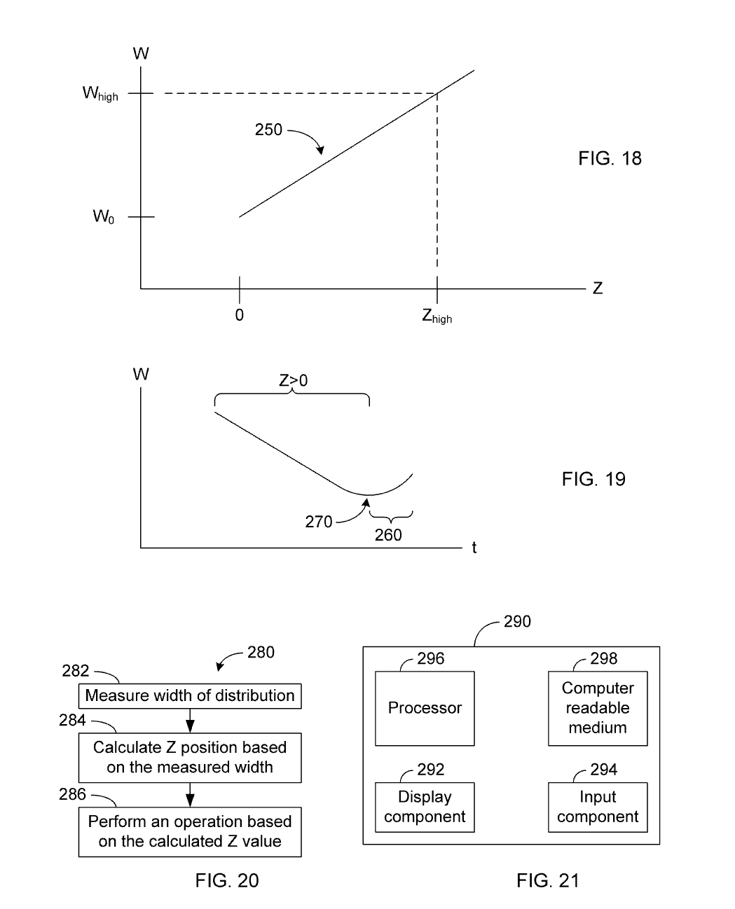

Based on the foregoing description in reference to FIGS. 15-17, a width W of a measured distribution can be related to a dimension D of an incidence region on the holographic layer 102, which in turn can be related to a separation distance Z of the object 140 from the holographic layer 102. For the example configuration where the dimension D of the incidence region is proportional to the distance Z (e.g., D=2Z tan θ when the incidence region is circular), the width W of the measured distribution can also be proportional to Z. FIG. 18 depicts such a proportional relationship between W and Z.

In certain embodiments (e.g., the linear relationship of FIG. 18), a monotonic relationship between W and Z can have a lower limit at Z=0. In certain embodiments, the value of W at Z=0 can be a minimum value corresponding to the contact situation as described in reference to FIG. 16.

In FIG. 18, an example upper limit of W_{high} is shown to be associated with an upper limit of Z_{high}. In certain embodiments, such upper limits can be provided based on the distribution width parameter (W) and/or the distance parameter (Z). For example, the upper width limit W_{high} can be based on the size of the line array detector so that detected signals provide sufficient coverage along X or Y direction to allow meaningful determination of the width of the detected distribution. In another example, the upper distance limit Z_{high} can be based on some zone depth above the holographic layer 102, beyond which detection of a reflecting object may not be desired. In such a situation, the distribution width (W) corresponding to the upper distance limit Z_{high} can be utilized to impose the distance limit.

In FIG. 18, it is assumed that the lower limit of the distribution width (W, corresponding to Z=0) is generally less than widths associated with Z>0 situations. Depending on the nature of the reflecting object 140, this is not necessarily always true. For example, if the object 140 is a fingertip and the pad portion of the fingertip is used to reflect the illumination light, then it is likely that contact surface area can vary significantly (at Z=0) due to deformation of the finger pad.

Touching of a surface by a fingertip can involve a range of pressure as the tip initially makes contact with the surface. At such a stage, the contact surface between the tip and the surface can be relatively small. As the fingertip continues to press on the surface, and assuming that the surface does not deform significantly, the pad can deform under increasing pressure, thereby increasing the contact surface. In certain embodiments, such an increase in the contact area can be detected by an increase in the width of the measured distribution.

In certain embodiments, the foregoing characterization of the contact property between the fingertip and the surface can be implemented separately and/or as an extension of the Z>0 position characterization as described herein. For example, FIG. 19 illustrates that in certain embodiments, width (W) of the measured distribution can be monitored as a function of time t. In FIG. 19, it is assumed that as time progresses, a reflecting object (e.g., a fingertip) approaches the holographic layer such that the width W decreases as Z decreases. Such a decrease in W is depicted by the Z>0 region. As the fingertip initially touches the holographic layer, the measured width W can have a minimum value indicated as 270. As the fingertip presses onto the holographic layer, a possible increase in contact surface resulting from increasing pressure can be detected as an increase in the detected width W. Such an increase in the measured width W after the initial contact is depicted by the region indicated as 260. It will be understood that similar monitoring of measured width W can be performed in the opposite direction as the fingertip is released from the holographic layer and moved away.

In the foregoing example, the in-contact situation and the non-in-contact situation (Z>0) can be distinguished by monitoring of the width W as a function of time t. In certain embodiments, such distinguishing can be achieved without having to rely on monitoring over some time period. In certain embodiments, a measured distribution associated with a contact situation and a measured distribution associated with a non-contact situation can be sufficiently different so as to be distinguishable without having to monitor the width change over time. For example, suppose that the contact situation yields a detectably sharper edge profile in the resulting distribution than that associated with the non-contact situation. Based on such a difference in the distribution profiles, a determination can be made as to whether the object is in contact with the holographic layer or not.

In the foregoing example, and as described herein in general, references are made to an object such as a fingertip touching or contacting the holographic layer. It will be understood that such touching or contact can include situations where the object touches or contacts the holographic layer directly, or where such touch or contact is made via one or more layers (e.g., a screen protector).

Based on the foregoing non-limiting examples, a number of functionalities can be implemented for a touchscreen device. FIG. 20 shows a process 280 that can be implemented to provide such a Z-position based functionality. In block 282, width of a measured distribution can be obtained. In block 284, Z position can be calculated based on the measured width. In certain embodiments, a Z≈0 position can be further characterized with respect to, for example, how the touchscreen is being touched. In block 286, one or more touchscreen related operations can be performed based on the calculated Z value and/or the characterization of the Z≈0 position.

FIG. 21 shows that in certain embodiments, one or more features of the present disclosure can be implemented via and/or facilitated by a system 290 having different components. In certain embodiments, the system 290 can be implemented in electronic devices such as portable computing and/or communication devices.

In certain embodiments, the system 290 can include a display component 292 and an input component 294. The display and input components (292, 294) can be embodied as the display and input devices 502 and 100 (e.g., FIG. 8), and be configured to provide various functionalities as described herein.

In certain embodiments, a processor 296 can be configured to perform and/or facilitate one or more of processes as described herein. In certain embodiments, a computer readable medium 298 can be provided so as to facilitate various functionalities provided by the processor 296.

In one or more example embodiments, the functions, methods, algorithms, techniques, and components described herein may be implemented in hardware, software, firmware (e.g., including code segments), or any combination thereof. If implemented in software, the functions may be stored on or transmitted over as one or more instructions or code on a computer-readable medium. Tables, data structures, formulas, and so forth may be stored on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, one or more processing units at a transmitter and/or a receiver may be implemented within one or more computing devices including, but not limited to, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a software implementation, the techniques described herein may be implemented with code segments (e.g., modules) that perform the functions described herein. The software codes may be stored in memory units and executed by processors. The memory unit may be implemented within the processor or external to the processor, in which case it can be communicatively coupled to the processor via various means as is known in the art. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Although the above-disclosed embodiments have shown, described, and pointed out the fundamental novel features of the invention as applied to the above-disclosed embodiments, it should be understood that various omissions, substitutions, and changes in the form of the detail of the devices, systems, and/or methods shown may be made by those skilled in the art without departing from the scope of the invention. Components may be added, removed, or rearranged; and method steps may be added, removed, or reordered. Consequently, the scope of the invention should not be limited to the foregoing description, but should be defined by the appended claims.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

1. A screen assembly for an electronic device, the screen assembly comprising:
a display device configured to display an image by providing signals to selected locations of the display device;
an input device disposed adjacent the display device, the input device comprising a holographic layer configured to receive incident light and direct the incident light towards at least one selected direction, the incident light resulting from scattering of at least a portion of illumination light from an object positioned relative to the holographic layer; and
a detector configured to detect the directed light and capable generating signals suitable for obtaining a distribution of the directed light along the at least one selected direction, the distribution having a parameter that changes substantially monotonically with a separation distance between the holographic layer and the object such that measurement of the parameter provides information about the separation distance.

2. The screen assembly of claim 1, wherein the display device comprises a plurality of light modulators.

3. The screen assembly of claim 2, wherein the light modulators comprise a plurality of interferometric light modulators.

4. The screen assembly of claim 1, further comprising a light guide disposed relative to the holographic layer so as to receive the directed light from the holographic layer and guide the directed light for at least a portion of the directed light's optical path to the detector.

5. The screen assembly of claim 4, wherein the detector comprises at least one line array detector that extends along a detection direction that is substantially perpendicular to the at least one selected direction, the line array detector configured to generate the signals for yielding the distribution along the detection direction thereby allowing determination of the separation distance and incidence location of the incident light along the detection direction.

6. The screen assembly of claim 5, further comprising one or more light sources configured to provide the illumination light to the object.

7. The screen assembly of claim 6, wherein the one or more light sources are positioned on the same side as the object relative to the holographic layer.

8. The screen assembly of claim 6, wherein the one or more light sources are positioned on the opposite side as the object relative to the holographic layer such that the illumination light from the one or more light sources pass through the holographic layer prior to the scattering from the object.

9. The screen assembly of claim 8, further comprising a light guide plate positioned adjacent the holographic layer and configured to direct light from the one or more light sources into the holographic layer as the illumination light.

10. The screen assembly of claim 1, wherein the parameter comprises a width of the distribution.

11. The screen assembly of claim 1, further comprising a processor configured to receive the signals and calculate the parameter of the distribution of the directed light.

12. The screen assembly of claim 11, further comprising a computer-readable medium accessible by the processor and having information that allows determination of the separation distance based on the calculated parameter.

13. A method for determining a distance of an object from a screen, the method comprising:
obtaining redirected light from an optical layer of the screen, the redirected light resulting from incidence of light scattered from the object at a distance from the screen, the optical layer configured to receive an incident ray that is within an acceptance range relative to the optical layer and redirect the accepted incident ray, the redirected light resulting from a collection of accepted incident rays from the object;
detecting the redirected light;
generating signals based on the detection of the redirected light;
obtaining a distribution of the redirected light based on the signals; and
calculating a width parameter from the distribution, the width of the distribution changing substantially monotonically with the distance such that the width provides information about the distance of the object from the screen.

14. The method of claim 13, wherein the optical layer comprises a holographic layer.

15. A touchscreen apparatus, comprising:
a holographic layer configured to receive accepted incident light and direct the incident light towards a selected direction, the accepted incident light resulting from scattering of illumination light from an object at or separated by a distance from a surface of the holographic layer;
a light guide disposed relative to the holographic layer so as to receive the directed light from the holographic layer and guide the directed light towards an exit portion of the light guide; and
a segmented detector disposed relative to the light guide and configured to detect the directed light exiting from the exit portion so as to allow determination of a distribution of the directed light along at least one lateral direction on the holographic layer, the distribution having a width that changes substantially monotonically the separation distance such that measurement of the width provides information about the separation distance.

16. The apparatus of claim 15, wherein the detection of the distribution of the directed light allows determination of a location along the at least one lateral direction on the holographic layer representative of an acceptance region on the holographic layer where the accepted incident light arrives from the object.

17. The apparatus of claim 16, wherein the distribution of the directed light is obtained along X and Y lateral directions relative to the holographic layer such that the information about the separation distance provides information about three-dimensional position of the object relative to the surface of the holographic layer.

18. The apparatus of claim 16, wherein the holographic layer is configured so as to have an acceptance range of incident angles, the acceptance range defined relative to the surface of the holographic layer.

19. The apparatus of claim 18, wherein the acceptance range comprises a cone defined about a line that is normal to the surface of the holographic layer, such that the accepted incident light arriving at the acceptance region from the object is generally within an inverted cone that opens from the object towards the holographic layer so as to project the acceptance region on the surface of the holographic layer.

20. The apparatus of claim 19, wherein the acceptance region on the surface of the holographic layer has a dimension that is substantially proportional to the width of the distribution, the dimension of the acceptance region further being substantially proportional to the distance, such that the distance is substantially proportional to the width of the distribution.

21. The apparatus of claim 16, wherein the substantially monotonic relationship between the width and the separation distance comprises a minimum value of the width when the object physically touches the surface of the holographic layer such that the separation distance is approximately zero.

22. The apparatus of claim 16, further comprising a light source disposed relative to the holographic layer and configured to provide light to the object to yield the accepted incident light.

23. The apparatus of claim 22, further comprising a light guide plate configured to receive light from the source and provide the light to the object from a side of the holographic layer that is opposite from the side where the object is located.

24. The apparatus of claim 23, wherein the light guide plate is disposed relative to the holographic layer such that the light guide is between the holographic layer and the light guide plate.

25. The apparatus of claim 22, further comprising:
a display;
a processor that is configured to communicate with the display, the processor being configured to process image data; and
a memory device that is configured to communicate with the processor.

26. The apparatus of claim 25, wherein the display comprises a plurality of interferometric modulators.

27. The apparatus of claim 25, wherein the detector is configured to communicate signal representative of the location of the acceptance region to the processor.

28. A method of fabricating a touchscreen, the method comprising:
forming a diffraction pattern in or on a substrate layer defining a plane and having first and second sides, the diffraction pattern configured such that a light ray incident at a selected angle on the first side of the substrate layer is diffracted into a turned ray that exits on the second side of the substrate layer along a direction having a selected lateral component parallel with the plane of the substrate layer;
coupling the substrate layer with a light guide layer that defines a plane substantially parallel to the plane of the substrate layer, the light guide layer being on the second side of the substrate layer and configured to received the turned light exiting from the substrate layer and guide the turned light substantially along the direction; and
coupling the light guide layer with a light guide plate such that the light guide layer is between the substrate layer and the light guide plate, the light guide plate configured to provide illumination light to an object on the first side of the substrate layer such that at least a portion of the illumination light scatters from the object and yields the incident light ray.

29. The method of claim 28, wherein the diffraction pattern comprises one or more volume or surface holograms formed in or on the substrate layer, and wherein the one or more holograms are configured such that the selected angle is within an acceptance cone that opens from a vertex on or near the first side of the substrate layer.

30. An apparatus comprising:
means for displaying an image on a display device by providing signals to selected locations of the display device; and
means for optically determining a separation distance between an input inducing object and a screen, the separation distance coordinated with the image on the display device, the separation distance obtained from measurement of a width of a distribution of light resulting from turning of accepted portion of scattered light from the object by a hologram.
